(19) United States
(12) Patent Application Publication
(10) Pub. No.: US 2001/0053984 A1
(43) Pub. Date: Dec. 20, 2001

(54) System, method, and process for analysis of patient treatment protocols

(76) Inventors: Karla Ann Joyce, New Brighton, MN (US); Perry Nicholas Kranz, Shoreview, MN (US); Susan Kay Kranz, Shoreview, MN (US)

Correspondence Address: Dr. Karla Joyce, Allay Technology, 3470 North Lexington, Shoreview, MN, 55126, US

(21) Appl. No.: 09/733,338

(22) Filed: Dec. 8, 2000

Related U.S. Application Data
(60) Provisional application No. 60/169,888, filed on Dec. 9, 1999.

(51) Int. Cl. G06F 17/60

(52) U.S. Cl. 705/2; 705/3

(57) ABSTRACT

A method of reviewing patient conditions and assessing treatment protocols is disclosed. In specific implementations, the method comprises determining both the patient's subjective medical condition and objective medical condition, and then combining information about the subjective and objective conditions to generate a treatment index. This treatment index is used to determine appropriate treatment frequency.

### FIELD OF THE INVENTION

The present invention relates generally to data processing systems, methods, and computer products; and more particularly to physical medicine and medical data processing systems, methods, and computer products useful in analyzing the treatment protocols of patients.

### BACKGROUND

The present invention pertains to the field of data processing systems for health care management, including physical medicine care. More specifically, the present invention pertains to a health care management data processing system for use by physical medicine practitioners and other health care providers who provide care to patients over extended periods of time. For example, the present invention is directed to patients having chronic back pain that requires multiple therapeutic sessions in order to regain their health.

Due to the increasing complexity and cost of providing health care, there is an ever-increasing emphasis on managing the health care process in order to maximize benefits to patients while controlling costs. A particularly great need exists for managing health care costs of health care conditions that require treatment over extended periods of time because the failure to properly treat such conditions can result in ongoing pain and discomfort for patients as well as increased expense for ineffective or inappropriate treatment.

Previous efforts to manage health care have included manual-historical systems where individual files recording actual treatment were manually reviewed to collect statistics on general categories of care or to review the appropriateness of care in a given case. Such methods are labor-intensive and inefficient. Efforts have also been made to standardize data collection forms, descriptions of conditions, descriptions of treatment, and treatments in order to more efficiently collect and evaluate health care data. Other efforts have been made to automate the analysis of historical health care data for persons with particular health care conditions. These efforts focus mainly on collecting financial data and serve accounting and administrative functions. However, such systems do not develop a treatment based on various data describing an individual's health condition. Also, these systems do not have the flexibility to modify or add treatments based on an individual's changing health condition.

It would be a decided improvement over the prior art to have a health care management data processing system that could be used by various health care participants at multiple stages of the health care process. A system implementing the above process should ideally have several qualities. It should be cost-effective, i.e., lead to reducing the total cost of care. It should be usable in real-time, i.e., the information input into the system should be immediately processed and available for further use. It should be interactive, allowing a variety of health care participants (doctors, nurses, administrators, quality evaluators) to understand and effectively use the system. It should be flexible enough to adapt to changes in and evolution of health care professional knowledge and health care treatment methods.

Therefore, a need exists for a health care management data processing system designed to more effectively manage the health care processes, including health care processes requiring repeated treatment of the patient.

### SUMMARY OF THE INVENTION

To overcome these and other problems in the prior art, the present invention provides a health care management data processing system. The invention includes a method of reviewing patient conditions and assessing treatment protocols. In specific implementations, the method comprises determining both the patient's subjective medical condition and objective medical condition, and then combining information about the subjective and objective conditions to generate a treatment index. This treatment index is used to determine appropriate treatment frequency.

In specific embodiments, the step of determining the patient's subjective medical condition comprises assessment of the severity and frequency of injury symptoms by the patient. The subjective data may comprise a patient's determination of their injury symptoms. The step of determining the patient's subjective condition may further include correction for redundant symptoms so as to give a more accurate representation of the patient's medical condition. Thus, if symptoms have overlapping properties, they may be adjusted to reflect a composite condition that does not excessively consider the overlapping properties.

The step of determining the objective condition of the patient may comprise performing and evaluating medical tests. When a plurality of tests is performed, the tests can be combined to obtain a composite indication of objective condition. Thus, although multiple objective tests are performed, a single objective indicia can be established to indicate the overall objective condition of a specific part of the anatomy of a patient or the overall objective condition of the patient. In making a composite indication, redundant tests may be eliminated in order to properly weight the composite. For example, if two tests are performed which are the same or substantially the same test, then one or more of the tests can optionally be discarded (or the two tests may be combined and averaged) prior to incorporation into the weighted composite.

Based upon these objective and subjective determinations, an index value can be obtained to indicate the condition of the patient and to plan subsequent treatment protocols. The present invention is advantageous in that the index value inherently reflects the specific condition of each individual patient because the medical condition is evaluated based on the specific symptoms of that patient. In addition, not only does the index reflect the patient's symptoms, but also reflects the patient's own view of his or her symptoms by incorporating the patient's own subjective assessment of their condition.

One of the objectives of certain implementations of the invention is to identify situations that have a particularly great relevance to successful and cost effective treatment of the patient. These highly relevant situations include conditions that indicate if the patient is not receiving proper care based upon their subjective and objective data. For example, if the index number of a patient has increased since the most recent treatment, there is an indication that the patient is not proceeding according to expectations, and that the condition may warrant further review. Thus, one situation of particularly great relevance is a condition in which the index number has increased, and preferred implementations of the invention include a determination of whether the index number has increased since the previous examination.

A further situation of particular relevance is a condition in which the subjective evaluation by the patient or health care provider (or both) is not supported by the objective indications. Therefore, certain implementations of the invention determine whether or not the objective findings support the level of subjective complaints. Similarly, certain implementations of the invention determine whether or not the objective findings are disproportionately high when compared to the level of subjective complaints.

Yet another situation of particular relevance exists when a determination is made that the diagnosis is linked to a part of the body for which there are no subjective complaints in the medical record or when the diagnosis is linked to a part of the body for which there are no objective findings listed in the medical record. Therefore, certain implementations of the invention identify and report such conditions.

The system of the present invention is useful for determining the proper course of care for patients, particularly patients having an injury or illness requiring extended treatment, such as back injuries requiring physical medicine care. Using the system, a health care organization can track treatment, evaluate whether treatment is successful, suggest alternative treatment, and highlight treatments that may be of particular concern, such as those showing a failure to improve the health of the patient. In this manner, patients benefit from receiving a proper level of care for an appropriate period. In addition, health care organizations, such as insurance companies, can reduce the extent of ineffective treatment, thereby promoting cost savings without inhibiting high quality treatment.

The above summary of the present invention is not intended to describe each illustrated embodiment of the present invention. The figures and the detailed description, which follow more particularly, exemplify variations of the disclosed embodiments.

### BRIEF DESCRIPTION OF THE FIGURES

Other aspects and advantages of the invention will become apparent upon reading the following detailed description and upon reference to the figures in which:

FIG. 1 is a flow chart depicting data processing system and method in accordance with the principles of an embodiment of the invention.

FIG. 2 is another flow chart depicting data processing in accordance with the principles of an embodiment of the invention.

FIG. 3 is a depiction of a computer display screen showing an interface for entering biographic data about a patient in accordance with the principles of an embodiment of the invention.

FIG. 4 is a depiction of a computer display screen showing an interface for entering claim data about a claim made by a patient in accordance with the principles of an embodiment of the invention.

FIG. 5 is a depiction of a computer display screen showing an interface for entry and presentation of information about a specific claim entered pursuant to an examination in accordance with the principles of an embodiment of the invention.

FIG. 6 is a depiction of a computer display screen showing an interface for entry and presentation of subjective data about a patient entered pursuant to an examination in accordance with the principles of an embodiment of the invention showing severity and frequency of the subjective data.

FIG. 7 is a depiction of a computer display screen showing an interface for presentation of objective data about a patient entered pursuant to an examination in accordance with the principles of an embodiment of the invention.

FIG. 8 is a depiction of a computer display screen showing an interface for presentation of a comparison of objective and subjective data about a patient in accordance with the principles of an embodiment of the invention.

FIG. 9 is a depiction of a computer display screen showing an interface for selecting reports that can be generated in accordance with the principles of an embodiment of the invention.

FIG. 10 is a depiction of a computer display screen showing an interface for indication of identified claims of particular concern.

FIG. 11 is a depiction of a computer display screen showing a description of conclusions drawn from analysis of the symptoms of a patient.

FIG. 12 is a flow chart showing an implementation for determining the subjective score of a patient.

FIG. 13 is a flow chart showing an implementation for determining the objective score of a patient.

While the invention is susceptible to various modifications and alternative forms, specifics thereof have been shown by way of example in the figures and will be described in detail. It should be understood, however, that the intention is not to limit the invention to the particular embodiments described. On the contrary, the intention is to cover modifications, equivalents, and alternatives falling within the spirit and scope of the invention as defined by the appended claims.

### DETAILED DESCRIPTION OF THE INVENTION

The present invention is described below in reference to the accompanying drawings, in which specific embodiments of the invention are shown. This invention may, however, be embodied in many different forms and should not be construed as limited to the embodiments set forth herein. As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code embodied in the medium. Any suitable computer readable medium may be utilized including hard disks, CD-ROMs, optical storage devices, or magnetic storage devices.

The present invention is described below with reference to flowchart illustrations of methods, apparatus (systems) and computer program products according to the invention. It will be understood that each block of the flowchart illustrations, and combinations of blocks in the flowchart illustrations, can be implemented by computer program instructions. These computer program instructions may be loaded onto a general purpose computer, special purpose computer, or other programmable data processing apparatus.

These computer program instructions may also be stored in a computer-readable memory that can direct a computer or other programmable data processing apparatus to function in a particular manner, such that the instructions stored in the computer-readable memory implement the function specified. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer instructions.

A typical data processing system within which the present invention can be implemented preferably includes a central processing unit, a display, a pointing device, a keyboard, and access to persistent data storage. The keyboard, having a plurality of keys thereon, is in communication with the central processing unit. A pointing device, such as a mouse, may also be connected to the central processing unit. The central processing unit contains one or more microprocessors or other computational devices and random access memory or its functional equivalent, including but not limited to, RAM, FLASHRAM, and VRAM for storing programs therein for processing by the microprocessor(s) or other computational devices.

The invention includes a method of reviewing patient care and assessing time-dependent treatment protocols. In specific implementations, the method comprises determining the patient's subjective medical condition and objective medical condition, and then combining information about the subjective and objective conditions to generate a treatment index. This treatment index is used to determine appropriate treatment frequency.

In specific embodiments, the step of determining subjective medical condition comprises assessment of the severity and frequency of injury symptoms by both the patient. The step of determining subjective patient condition data may comprise a patient's determination of their injury symptoms.

The step of determining the patient's objective condition may comprise performing and evaluating medical tests. When a plurality of tests is performed, they may be combined to obtain a composite indication of the patient's objective condition. Thus, although multiple objective tests are performed, a single objective indicia can be established to indicate the overall objective condition of the patient. In making a composite indication, redundant tests may be eliminated in order to properly weight the composite. For example, if two tests are performed which are the same or substantially the same test, then one or more of the tests can optionally be discarded or the two tests may be combined and averaged prior to incorporation into the weighted composite.

One of the objectives of certain implementations of the invention is to identify situations that have a particularly great relevance to successful and cost effective treatment of a patient. These highly relevant situations include conditions, which indicate that the patient is not receiving proper care based upon their subjective and objective data.

One situation of particularly great relevance is a condition in which the index number has increased. Preferred implementations of the invention include a determination of whether the index number has increased since the previous examination. A further situation of particular relevance is a condition in which the subjective evaluation by the patient or health care provider (or both) is not supported by objective indications. Therefore, certain implementations of the invention determine whether or not the objective findings support the level of subjective complaints. Similarly, certain implementations of the invention determine whether or not the objective findings are disproportionately high when compared to the level of subjective complaints.

Yet another situation of particular relevance exists when a determination is made that the diagnosis is linked to a part of the body for which there are no subjective complaints in the medical record or when the diagnosis is linked to a part of the body for which there are no objective findings listed in the medical record. Therefore, certain implementations of the invention identify and report such conditions.

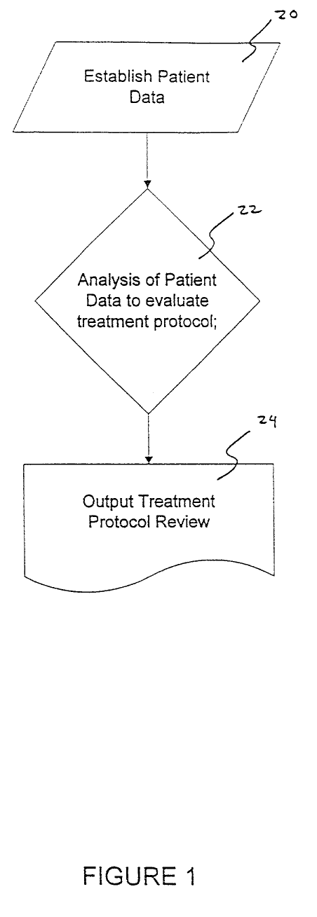

In reference now to FIG. 1, a simplified flow chart is depicted showing progression from establishing 20 patient data through analysis 22 of patient data to evaluate the treatment protocol, and output 24 of information about the treatment protocol review. In the first step of establishing 20 patient data, one or more examinations of a patient are made. This examination(s) determines the subjective and objective characteristics of the patient's medical condition. In the second step of analysis of patient data 22 the subjective and objective data are analyzed to evaluate the condition of the patient and determine a proper treatment procedure and to evaluate ongoing treatment procedures. In the third step of output 24 of information about the treatment protocol review, the results of the analysis 22 are provided. This output 24 may include, for example, one or more reports relating to the examination, to the analysis, to problems with the diagnosis or treatment plan, a diary, a summary of treatment, etc.

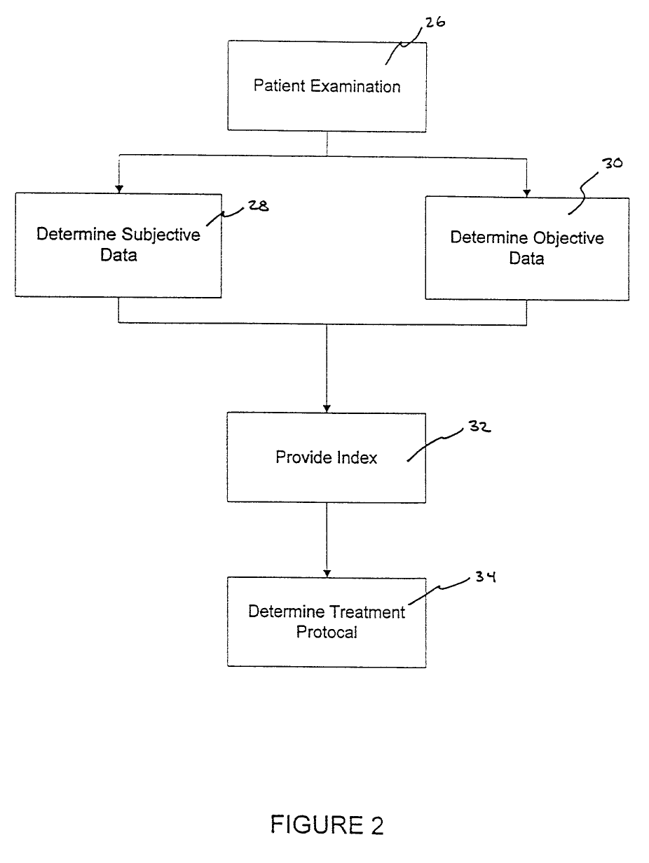

A flow chart of an embodiment of the invention is shown in greater detail in FIG. 2. In FIG. 2, the patient examination 26 is conducted, from which a determination of subjective data 28 and objective data 30 is made. In this embodiment, the subjective and objective data 28, 30 is combined to provide an index 32. The index 32 reflects a combination of the subjective and objective data 28, 30 in a manner useful to determine and evaluate treatment protocols based upon the index 32. Thus, the severity of a medical condition and the time necessary to treat that medical condition preferably correlates to index 32. In certain implementations, discussed more fully below, the subjective data and objective data are combined in a fashion such that the index reflects weighting of the subjective and objective data 28, 30 as well as elimination of redundant data to provide a more accurate index 32. The index 32 is subsequently used to determine the treatment protocol 34, which can include the evaluation of existing treatment as well as suggestion of future treatments.

The present invention advantageously combines the subjective data 28 and objective data 30 in order to provide the combined index 32. This combination of subjective and objective data is advantageous because it reflects both the subjective experiences, observations, and evaluations of both a health care provider as well as the empirical indications of clinical tests relating to objective data. Thus, the present invention is advantageous because it relies on the actual conditions of each individual patient to make a treatment determination, and is not simply based upon a database of objectively similar patients. Patients who have objectively comparable symptoms do not necessarily receive the same expected treatment due to variations in their subjective conditions as well as their individual response to care. In this manner, the present system and method makes individualized assessments about each patient's conditions.

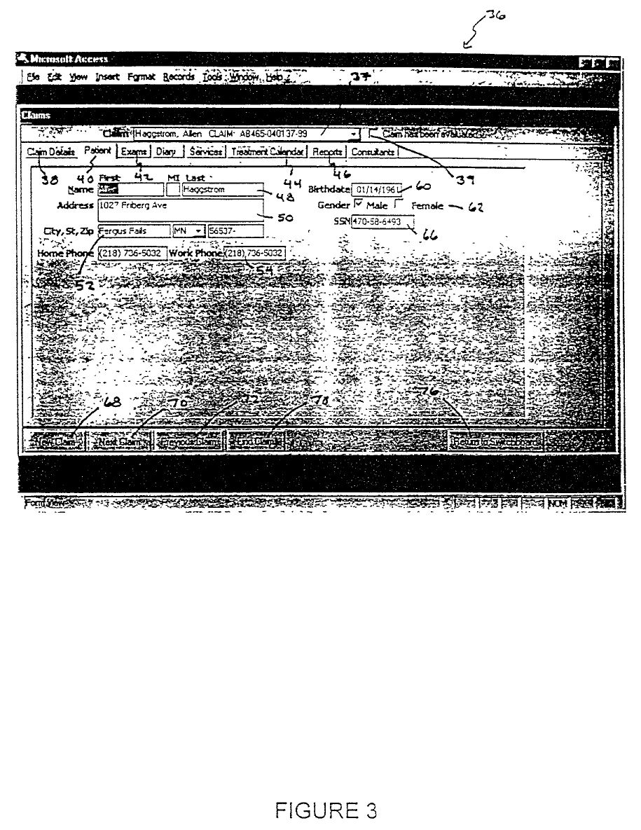

In reference now to FIGS. 3 to 11, various exemplary computer screen displays for implementing the present invention are shown. FIG. 3 shows of a computer display screen having an interface for entering claim data about a claim made by a patient in accordance with the principles of an embodiment of the invention. Display screen 36 includes tracking information 37 about the claim, as well as an indicator 39 for whether or not the claim has already been evaluated. The display screen 36 allows for selection of various information about the claim, including claim details 38, patient information 40 (shown selected in display 36), examinations 42, treatment calendar 44, and reports 46. Other information, including diaries, services, and consultants are also provided in the depicted embodiment.

Display screen 36 includes information about the patient, including the patient's name 48, address 50, and telephone numbers 52, 54. The embodiment also provides for entry of the patient's birthday 60, gender 62, and identifier number 66 (such as social security number, “SSN”). It will be appreciated that this information can be tailored for the specific application, and thus not all of this information will always be necessary, and in addition other information may be necessary. Also, it will be appreciated that in certain implementations of the invention the information displayed regarding the patient will not be viewable by all parties with access to the system. Thus, a reviewer at an insurance company may have access to the patient's information based upon identification number but not based upon the patient's biographical information. In this manner, the patient information can be maintained in a confidential manner and provided as necessary only to those persons with a reason to see that data.

In addition, control buttons are provided in the depicted implementation for moving between claims. Thus, controls are provided for adding new claims 68, moving to the next claim 70, review of a previous claim 72, and to find a claim 74. A control 76 for return to a main screen of the program is also provided.

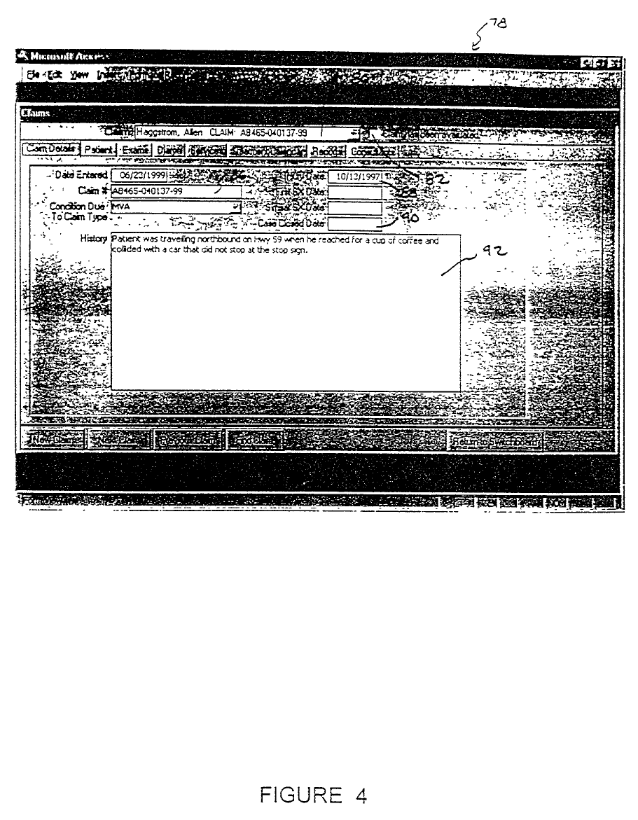

Reference is now made to FIG. 4, which is a depiction of a computer display screen showing an interface 78 for presentation of information about a specific claim entered pursuant to an examination. General claim information is also displayed in the depicted embodiment, including tracking information 80 and a indicator 82 of whether or not the claim has been evaluated. Text boxes are provided in the depicted embodiment for the date the claim was entered 84, the claim number 86, the date of the injury 88, and other relevant dates, including the date on which the case closed 90 (if it has closed). In the embodiment shown, a history text box 92 indicates the nature of the injury, such as the manner in which the injury occurred or any change in conditions since the injury occurred or treatment commenced.

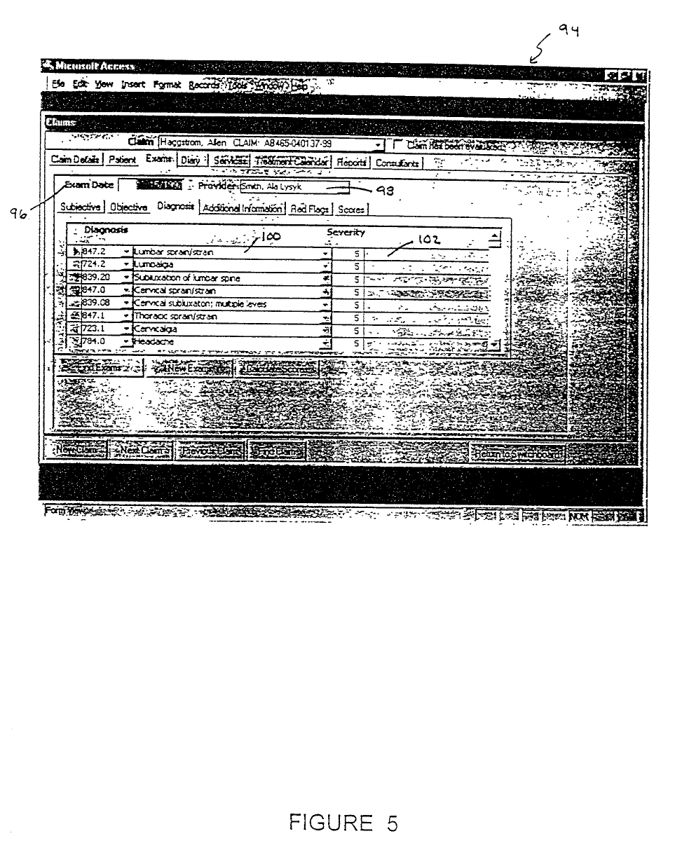

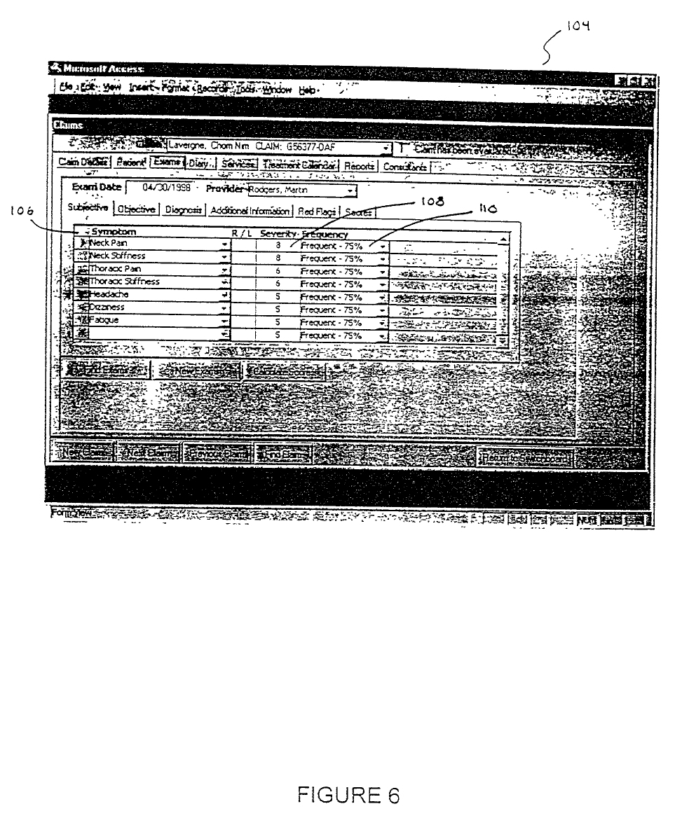

Reference is now made to FIGS. 5 and 6, which depict an interface for presentation of data about a patient entered pursuant to an examination in accordance with the principles of an embodiment of the invention. In addition to showing basic information, such as the examination date 96 and health care provider 98, the diagnosis is indicated, including the location or type of injury 100 and the severity of the injury 102. The severity of the complaint is normally represented as a scaled numeric function. In the embodiment represented in FIG. 6, severity is measured on a scale of 1 to 10, with a severity of 1 being mild and 10 being severe. The frequency of the symptoms is also typically measured, and may be giving on a percentage basis. Thus, for example, the frequency may be considered to be “constant” if the symptoms are present 100 percent of the time, “frequent” if the symptoms are present approximately 75 percent of the time, “occasional” if the symptoms are present 50 percent of the time, and “intermittent” if the symptoms are present 25 percent of the time. In a specific embodiment of the invention, the frequency is measured by querying the patient whether the symptoms are constant, frequent, occasional, or intermittent. This query may be conducted by, for example, having the patient fill out a form or by asking the patient about their conditions.

In a specific implementation of the invention, the severity and frequency of the symptoms are combined to give an overall complaint score. Typically, those symptoms that are most severe and most frequent will receive a higher complaint score, indicating a more severe condition. In one method of making the combination is to multiply the severity by a number tracked to the frequency. For example, a “constant” frequency may receive a multiple of 1.25, an “frequent” frequency may receive a multiple of 1.0, an “occasional” frequency may receive a multiple of 0.5, and an “intermittent” frequency may receive a multiple of 0.5. Thus, a moderately severe injury with a 7.0 severity number but only intermittent frequency will have a complaint score of 7.0×0.5=3.5.

An example of such methodology is shown in FIG. 6, where the display 104 provides places for selecting the symptom 106, entering the severity 108, and entering frequency 110. In the depicted embodiment for an example claim, all of the symptoms are described as being frequent. Neck pain and neck stiffness are the most severe symptoms, both receiving an indication of an 8 for severity, while headache, dizziness, and fatigue are described as being less severe, with a indication of 5 for severity.

In addition to gathering subjective data about the patient's condition, the present method and system reviews the objective information about the patient's condition. As used herein, objective information refers to the patient's condition as measured by various tests. This objective information is preferably converted to a specific objective score. Depending upon the type of test performed, various scaled scores are provided. If the test measures a degree of motion, a score value in one implementation may be determined by the following formula:

$$\frac{NormalRange - MeasuredRange}{NormalRange} \times 10$$

This measurement gives an indication of the amount of motion loss. Thus, if the normal degree range of motion is 90, but the measured range of motion is 30, then the score value is ((90−30)/90)×10=6.7. Alternative formulations for producing a score value for degree of motion changes are also anticipated.

When the objective test results in a scaled number, then this scaled number can also be converted into a score value. For example a 3-point scale can convert to a score according to Table 1 below:

TABLE 1

| Scale Number | Severity | Score |
|---|---|---|
| 3 | severe | 9 |
| 2 | moderate | 6 |
| 1 | mild | 3 |

It will be noted that the example 3-point scale shown above is provided for exemplary purposes only. If the scale were to be inversely correlated to injury, such that a scale number of 3 is mild, then the score would also be inversely correlated and the scale number of 3 would receive a score of 3.

Another example of a method of converting the scale number to severity is shown below in Table 2. Here, the scale is a 5-point scale and the severity runs from normal to absent.

TABLE 2

| Scale Number | Severity | Score |
|---|---|---|
| 5 | normal | 0 |
| 4 | good | 2 |
| 3 | fair | 4 |
| 2 | poor | 6 |
| 1 | trace | 8 |
| 0 | absent | 10 |

Table 3, below, provides yet another exemplary scale conversion, here showing conversion of a Wexler measurement to a scaled score.

TABLE 3

| Scale Number | Severity | Score |
|---|---|---|
| 4+ | hyperactive with | 6 |
| | clonus | |
| 3+ | hyperactive; without | 3 |
| | clonus | |
| 2+ | normal | 0 |
| 1+ | hypoactive | 4 |
| 0 | absent | 9 |

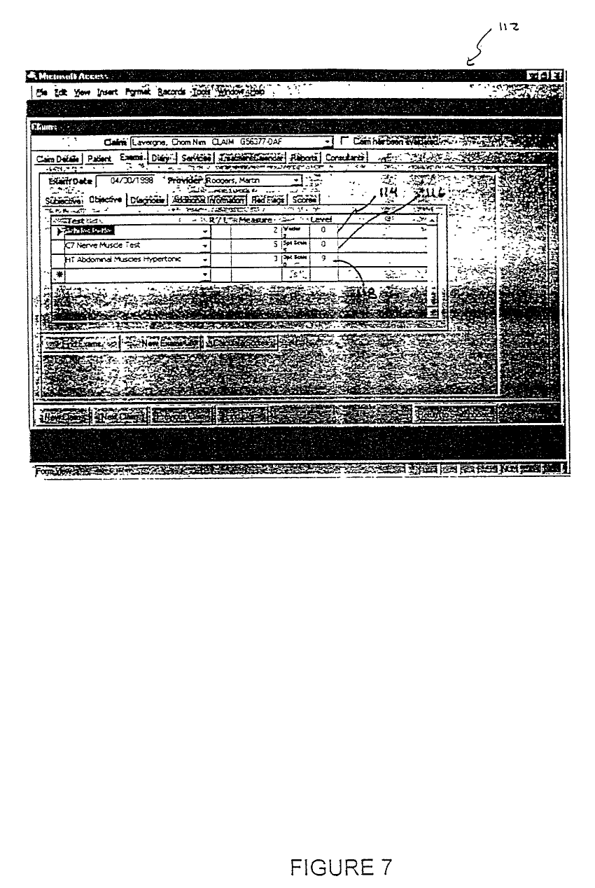

An example of entry of these measurements is shown in FIG. 7, which depicts a computer display screen showing an interface 112 for presentation of objective data about a patient entered pursuant to an examination in accordance with the principles of an embodiment of the invention. Three different tests are shown. The first 114, Achilles Reflex, indicates a measurement of 2 on a Wexler scale, which correlates to normal and a score of 0. The second 116, C7 Nerve Muscle Test, indicates a measurement of 5 on a 5-point scale and a score of 0. The third 118, HT abdominal Muscles Hypertonic test, indicates a measurement of 3 on a 3-point scale and a score of 9.

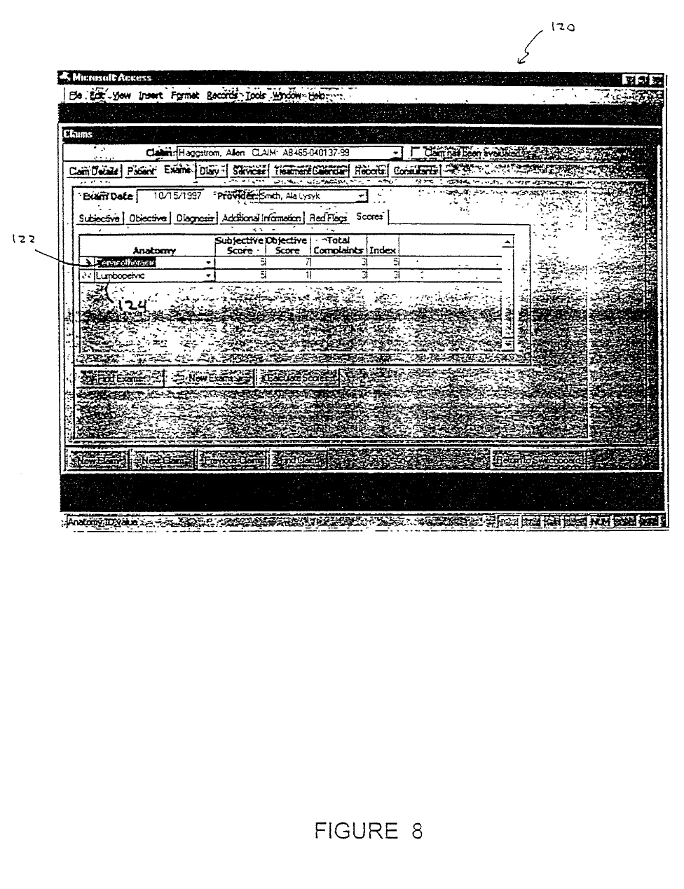

In the depicted implementation, the subjective and objective scores of a patient are combined to give the patient an index value for each portion of their anatomy. FIG. 8 is a depiction of a computer display screen showing an interface 120 for presentation of a comparison of objective and subjective data about a patient in accordance with the principles of an embodiment of the invention. The cervothoracic portion of the anatomy 122 receives a subjective sore of 5, and an objective score of 7 based on a total number of complaints of 5. The lumbopelvic portion 124 receives a subjective score of 5 and an objective score of 7 based on a total number of complaints of 3.

The subjective and objective scores are combined to produce an index score. For example, in one implementation the index score is determined by adding the highest subjective score to the total objective score and dividing by 2.25. This index score can be used to determine treatment frequency and the maximum frequency of treatment that would be considered reasonable. This evaluation is based on the highest index score, the number of weeks since the onset of treatment, and the highest subsequent index scores. Typically, the treatment frequency is recalculated after each additional examination.

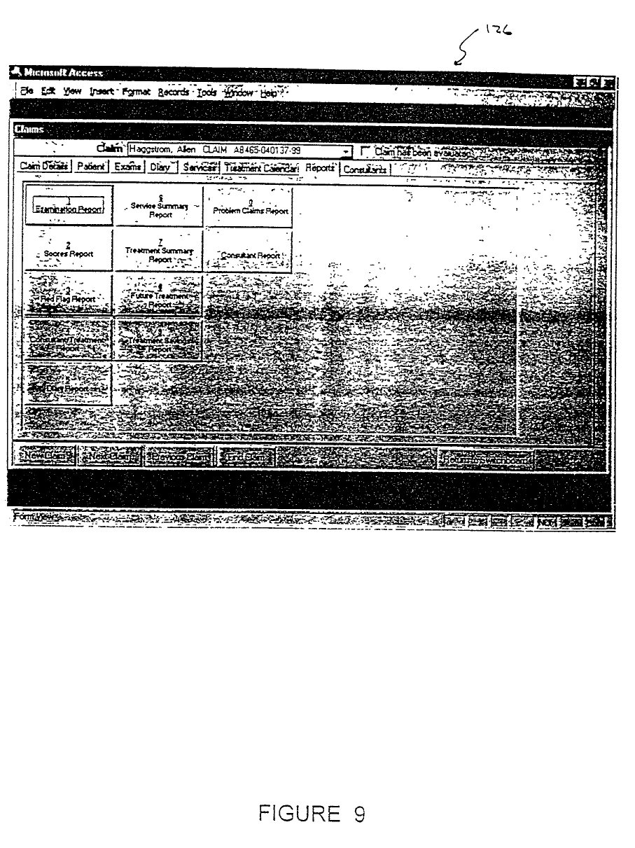

Various reports may be produced based upon the analysis of the patient data. FIG. 9 is a depiction of a computer display screen 126 showing an interface for selecting reports that can be generated in accordance with the principles of an embodiment of the invention. These reports include examination reports, score reports, red flag reports (indicating claims of special concern), consultant/treatment reports, diary reports, service summary reports, treatment summary reports, future treatment reports, treatment savings reports, problem claims reports, and consultant reports.

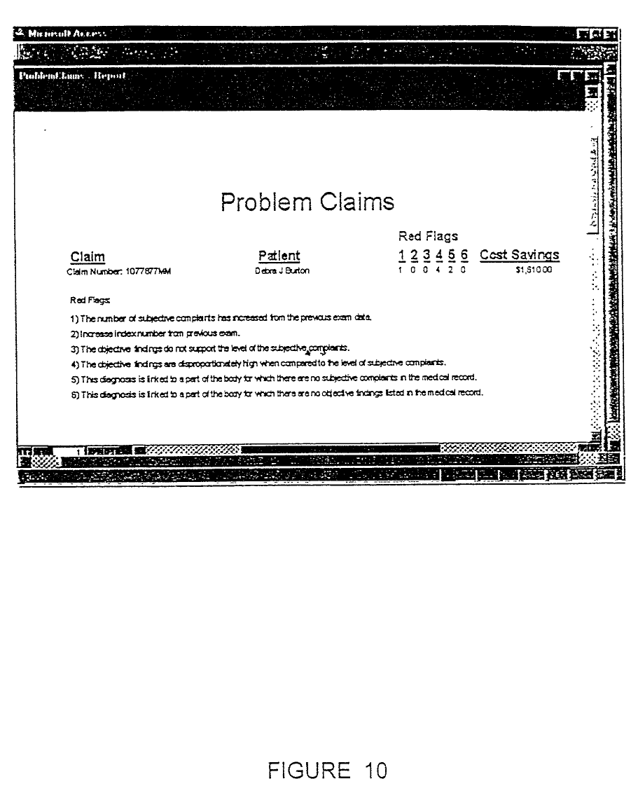

FIG. 10 is a depiction of a computer display screen showing an interface for indication of identified claims of particular concern. Various “red flags” or situations of particular concern are indicated, including whether the number of subjective complaints have increased from the previous exam data; whether there has been an increase in the index number from the previous exam, whether the objective findings do not support the level of the subjective complaints, whether the objective findings are disproportionately high when compared to the level of subjective complaints, whether the diagnosis is linked to a part of the body for which there are no subjective complaints in the medical record; and whether this diagnosis is linked to a part of the body for which there are no objective findings listed in the medical record.

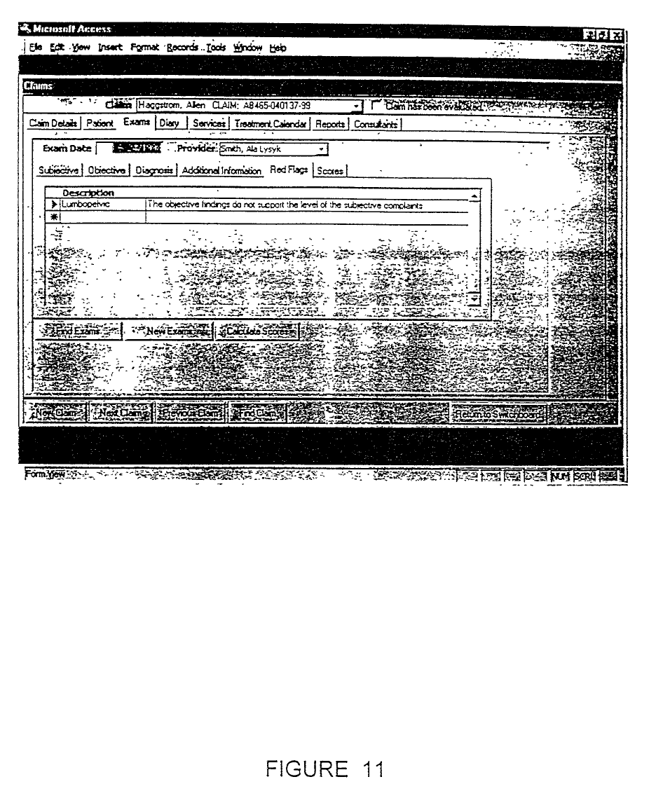

FIG. 11 shows a depiction of a computer display screen showing an interface for presentation of conclusions drawn from analysis of the symptoms of a patient. As indicated, the conclusion of the displayed patient as one that the objective findings do not support the level of the subjective complaints. Such indications provide a red flag that additional inquiry may be needed or that a change in treatment is necessary.

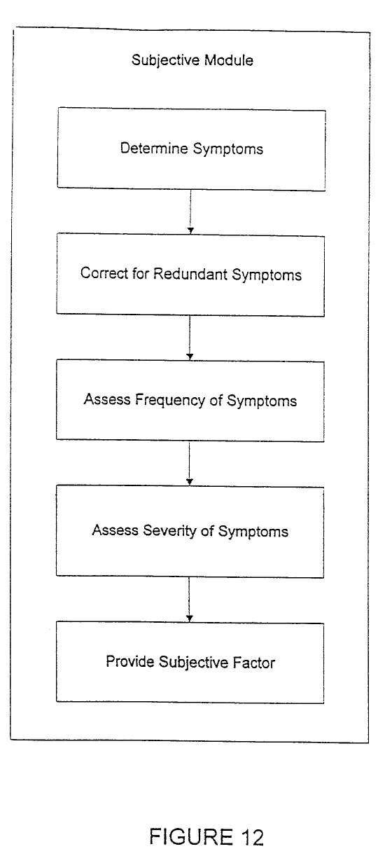

FIG. 12 is a flow chart showing an implementation for determining the subjective score of a patient. In the implementation shown, the symptoms are determined, and then redundant symptoms are eliminated in a step of correcting for redundant systems. Thereafter, the frequency of the symptoms and their severity are assessed. Based upon these steps, the subjective factor or score is provided.

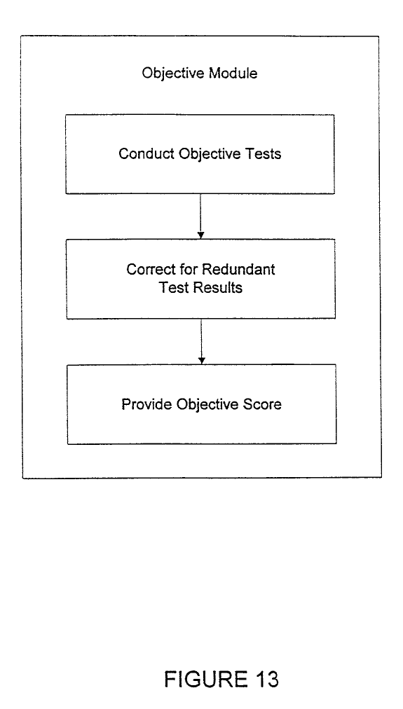

FIG. 13 is a flow chart showing an implementation for determining the objective score of a patient. In the embodiment depicted, objective tests are conducted, redundant test results are removed, and an objective test score is provided.

The present invention provides further advantages in that it allows for evaluation of a patient's condition over time, and thus evaluates not just the static condition of a patient but also their prior condition and any changes to their prior condition as indicated by objective data, subjective data, or both. For example, in one implementation of the invention the system and process assess the progress of a patient to determine whether or not the patient is showing the expected improvement in their condition. If the progress is slower than expected, based upon the objective and subjective data, then changes in the treatment evaluation may be necessary. Furthermore, such variations from the anticipated course of treatment can be used to further modify future treatment methods.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clause are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A method of reviewing patient care and assessing time-dependent treatment protocols, the method comprising:
a) determining subjective data of the patient's medical condition;
b) determining objective data of the patient's medical condition;
c) combining the subjective and objective data to generate a treatment index; and
d) using the treatment index to determine appropriate treatment frequency.

2. The method according to claim 1, wherein the step of determining subjective data comprises review of the severity and frequency of injury symptoms.

3. The method according to claim 1, wherein the step of determining subjective data further includes correction for redundant symptoms.

4. The method according to claim 2, wherein the step of determining subjective data comprises review of the severity and frequency of injury includes correction for redundant symptoms.

5. The method according to claim 1, wherein the step of determining objective data comprises review of test results.

6. The method according to claim 1, wherein the step of determining objective data comprises combining a plurality of tests to obtain a composite objective data score.

7. The method according to claim 6, wherein the step of determining objective data comprises eliminating similar tests.

8. The method according to claim 6, wherein the step of combining the subjective and objective data to form an index comprises identification of cases in which the number of subjective complaints has increased from the previous examination.

9. The method according to claim 6, wherein the step of combining the subjective and objective data to form an index comprises determination of whether the index number has increased since the previous examination, or the number of subjective complaints has increased from the previous exam data.

10. The method according to claim 6, wherein the step of combining the subjective and objective data to form an index comprises determination of whether or not the objective findings support the level of subjective complaints.

11. The method according to claim 6, wherein the step of combining the subjective and objective data to form an index comprises determination of whether or not the objective findings are disproportionately high when compared to the level of subjective complaints.

12. The method according to claim 6, wherein the step of combining the subjective and objective data to form an index comprises identification of whether the diagnosis is linked to a part of the body for which there are no subjective complaints in the medical record.

13. The method according to claim 6, wherein the step of combining the subjective and objective data to form an index comprises identification of whether the diagnosis is linked to a part of the body for which there are no objective findings listed in the medical record.

14. The method according to claim 1, further comprising a patient examination.

15. The method according to claim 1, further comprising preparing a report.
